(19) United States
(12) Patent Application Publication
(10) Pub. No.: US 2015/0362596 A1
(43) Pub. Date: Dec. 17, 2015

(54) STATE DETECTING METHOD, CORRECTION VALUE PROCESSING DEVICE, POSITIONING SYSTEM, AND STATE DETECTION PROGRAM

(71) Applicant: NEC CORPORATION, Tokyo (JP)

(72) Inventor: Yutaka NOZAKI, Tokyo (JP)

(73) Assignee: NEC Corporation, Tokyo (JP)

(21) Appl. No.: 14/764,476

(22) PCT Filed: Feb. 25, 2014
(86) PCT No.: PCT/JP2014/000964

§ 371 Date: Jul. 29, 2015

(30) Foreign Application Priority Data
Feb. 26, 2013 (JP) 2013-035783

(51) Int. Cl. G01S 19/07

(52) U.S. Cl. CPC G01S 19/07

(57) ABSTRACT

[Subject]

To provide a state detecting method of detecting an abnormal state of a base station with high precision in a positioning system having a satellite and a base station, a positioning system, and a program.

[Solving Means]

A state detecting method of detecting an abnormal state of a base station in a positioning system having a satellite and a base station, including: obtaining a first positioning position of the base station on the basis of a signal received from the satellite by the base station; selecting predetermined number of master base stations in ascending order of a distance between preliminarily given position information of the base station and the first positioning position of the base station; generating a correction value of the master base station on the basis of a signal received from the satellite by the master base station; obtaining a second positioning position of a base station other than the master base station by correcting the first positioning position of the base station other than the master base station with the correction value of the master base station by the base station other than the master base station; and determining that the base station other than the master base station is in an abnormal state when the distance between a position by preliminarily given position information of the base station other than the master base station and the second positioning position is larger than a first threshold.

### TECHNICAL FIELD

The present invention relates to a state detecting method, a correction value processing device, a positioning system, and a state detection program and, more particularly, relates to a method of detecting an abnormal state of a base station in a differential GPS having a plurality of base stations.

### BACKGROUND ART

In recent years, scenes of performing positioning by using a GPS (Global Positioning System) are increasing, and dependence on a GPS in daily life is increasing.

A delay may occur in propagation by the influence of the ionosphere and aerosphere in which radio waves carrying signals propagate such as a case of receiving a signal from a GPS satellite from a low elevation angle, and there is a limit on precision of positioning using a GPS.

A differential GPS whose precision of positioning by a GPS is improved by installing a base station fixed to the surface of the earth in order to solve the problem is being spread.

However, the positioning precision of a differential GPS depends on the precision of the time and position of a base station. For example, when abnormality occurs in the operation of a base station, it affects a correction signal. A GPS user receiver which receives the correction signal, corrects a signal received from a GPS satellite, and performs positioning estimates a position different from a correct position as the position of itself.

The influence of an error in positioning by a GPS to the daily life is enormous. Consequently, the differential GPS is requested to detect a failure in the operation of a base station early and avoid influence on the correction value.

A requirement determined for a base station of a differential GPS currently operated as the GBAS (Ground Based Augmentation System) standard is that an integrity risk is 10⁻⁵ per 150 seconds. The integrity risk denotes integrity loss probability. The requirement is determined by the ICAO (International Civil Aviation Organization)/RTCA (Radio Technical Commission for Aeronautics). The probability that two base stations satisfying the requirement fail at the same time is about 10⁻¹⁰. In operation of the GBAS, this numerical value may be ignored in the category I (CAT-I) in which the integrity risk as a requirement is 10⁻⁷ but is unignorable in the categories II and III (CAT-II/III) in which the integrity risk is 10⁻⁹.

PTL 1 discloses a method of detecting a base station in which abnormality occurs in a differential GPS (DGPS) using a plurality of base stations. When N pieces of GPS satellites and K pieces of base stations are specified by being designated with indexes “n” and “k”, a receiver/satellite specific differential adjusted value adjusted so that clock bias is removed and common measurement time is reflected is set as C^{n,k}. The receiver/satellite specific differential adjusted value is generated by differential adjustment processing means on the basis of a GPS signal received from a GPS satellite. First, on the basis of the received GPS signal and the known measurement position of a GPS signal receiver of a base station fixed to the surface of the earth, a satellite specific differential adjusted value is generated. The GPS signal receiver has a clock time offset or bias from the atomic clock time of the GPS satellite, and receiver/satellite specific measurement values have different measurement times. The GPS signal receiver generates a differential adjusted value accompanying no clock bias from the receiver/satellite specific measurement values. Then, the GPS signal receiver adjusts the receiver/satellite specific adjusted values in accordance with common synchronization time. By the processes, the receiver/satellite specific differential adjusted value C^{n,k} adjusted so that the clock bias is eliminated and common measurement time is reflected is obtained.

It is now assumed that a satellite specific differential adjusted average value is a value <Cⁿ> obtained by performing arithmetic averaging on the receiver/satellite specific differential adjusted values C^{n,k} adjusted so that the clock bias is eliminated and common measurement time is reflected among the base stations. That is, the satellite specific differential correction average value is obtained by the following relational equation.

<Cⁿ>=(1/K)(C^{n,1}+C^{n,2}+ . . . +C^{n,K})

As an amount used for a test, receiver-satellite-specific discriminant value Z^{n,k} is used. It is assumed that the receiver-satellite-specific discriminant value Z^{n,k} is the difference between the receiver/satellite specific differential adjusted value C^{n,k} and the satellite specific differential correction average value <Cⁿ>. That is, it is obtained by the following relational equation.

Z^{n,k}=C^{n,k}−<Cⁿ>

At this time, by a predetermined detection threshold DT^{n,k}, determination of a base station is performed. That is, a base station is determined by the following determination equation.

|Z^{n,k}|>DT^{n,k}

Concretely, in the case where the determination equation |Z^{n,k}|>DT^{n,k} is satisfied in all of GPS satellites (n=1, . . . , N) to a given base station k, it is determined that the base station k has abnormality.

PTLs 2 to 5 also disclose related arts.

### CITATION LIST

PTL 1: U.S. Pat. No. 5,600,329
PTL 2: Japanese Unexamined Patent Application Publication No. 2003-057327
PTL 3: Japanese Unexamined Patent Application Publication No. 2007-010422
PTL 4: Japanese Unexamined Patent Application Publication No. 2009-168804
PTL 5: Japanese Unexamined Patent Application Publication No. 2011-043449

### SUMMARY OF INVENTION

### Technical Problem

In the PTL 1, a base station in which abnormality occurs can be detected but there is a problem as described below. A test by the determination expression is performed only in the range domain (measurement of the distance from a GPS user receiver (such as an aircraft) to a GPS satellite). Therefore, in the case where the absolute value of the receiver-satellite-specific discriminant value is less than the threshold, it is not regarded that abnormality occurs. However, when the sign of the receiver-satellite-specific discriminant value is deviated to the negative side or the positive side, it is feared that a critical position error occurs in a position domain (determination of the position of the GPS user receiver). In addition, in calculation of the average value among base stations, a correction value from a base station in which abnormality occurs is also included, and it cannot be said that the determination of presence/absence of abnormality is accurately reflected in the receiver-satellite-specific discriminant value used for the test. For example, for an abnormal base station, the receiver-satellite-specific discriminant value becomes small, and there is the possibility that a detection failure occurs. For a base station which is not abnormal, the receiver-satellite-specific discriminant value increases, and erroneous detection may occur.

### Solution to Problem

To achieve the object, a state detecting method of the present invention is a state detecting method of detecting an abnormal state of a base station in a positioning system having a satellite and a base station and includes the steps of: obtaining a first positioning position of the base station on the basis of a signal received from the satellite by the base station; selecting predetermined number of master base stations in ascending order of a distance between preliminarily given position information of the base station and the first positioning position of the base station; generating a correction value of the master base station on the basis of a signal received from the satellite by the master base station; obtaining a second positioning position of a base station other than the master base station by correcting the first positioning position of the base station other than the master base station with the correction value of the master base station by the base station other than the master base station; and determining that the base station other than the master base station is in an abnormal state when the distance between a position by preliminarily given position information of the base station other than the master base station and the second positioning position is larger than a first threshold.

A state detecting method of the present invention is a state detecting method of detecting an abnormal state of a plurality of base stations in a positioning system having a satellite and the plurality of base stations and includes the steps of: obtaining a first positioning position of the base station on the basis of a signal received from the satellite by the base station; selecting, as a master base station, a base station whose distance between preliminarily given position information of the base station and the first positioning position of the base station lies in a predetermined range; generating a correction value of the master base station on the basis of a signal received from the satellite by the master base station; obtaining a second positioning position of a base station other than the master base station by correcting the first positioning position of the base station other than the master base station with the correction value of the master base station by the base station other than the master base station; and determining that the base station other than the master base station is in an abnormal state when the distance between a position by preliminarily given position information of the base station other than the master base station and the second positioning position is larger than a first threshold.

A correction value processing device of the present invention includes: data receiving means receiving a signal received from a satellite by a base station; first positioning position calculating means calculating a first positioning position of the base station on the basis of the signal received by the data receiving means; master base station selecting means selecting predetermined number of master base stations in ascending order of a distance between preliminarily given position information of the base station and the first positioning position of the base station; master base station correction value calculating means generating a correction value of the master base station on the basis of a signal received from the satellite by the master base station; second positioning position calculating means calculating a second positioning position of a base station other than the master base station by correcting the first positioning position of the base station other than the master base station with the correction value of the master base station by the base station other than the master base station; and abnormality determining means determining that the base station other than the master base station is in an abnormal state when the distance between a position by preliminarily given position information of the base station other than the master base station and the second positioning position is larger than a first threshold.

A correction value processing device of the present invention includes: data receiving means receiving a signal received from a satellite by a base station; first positioning position calculating means calculating a first positioning position of the base station on the basis of the signal received by the data receiving means; master base station selecting means selecting, as a master base station, a base station whose distance between preliminarily given position information of the base station and the first positioning position of the base station lies in a predetermined range; master base station correction value calculating means generating a correction value of the master base station on the basis of a signal received from the satellite by the master base station; second positioning position calculating means calculating a second positioning position of a base station other than the master base station by correcting the first positioning position of the base station other than the master base station with the correction value of the master base station by the base station other than the master base station; and abnormality determining means determining that the base station other than the master base station is in an abnormal state when the distance between a position by preliminarily given position information of the base station other than the master base station and the second positioning position is larger than a first threshold.

A positioning system of the present invention is a positioning system having a satellite, a base station, and a correction value processing device, wherein the correction value processing device includes: first positioning position calculating means calculating a first positioning position of the base station on the basis of the signal received by the data receiving means; master base station selecting means selecting predetermined number of master base stations in ascending order of a distance between preliminarily given position information of the base station and the first positioning position of the base station; master base station correction value calculating means generating a correction value of the master base station on the basis of a signal received from the satellite by the master base station; second positioning position calculating means calculating a second positioning position of a base station other than the master base station by correcting the first positioning position of the base station other than the master base station with the correction value of the master base station by the base station other than the master base station; and abnormality determining means determining that the base station other than the master base station is in an abnormal state when the distance between a position by preliminarily given position information of the base station other than the master base station and the second positioning position is larger than a first threshold.

A positioning system of the present invention is a positioning system having a satellite, a base station, and a correction value processing device, wherein the correction value processing device includes: first positioning position calculating means calculating a first positioning position of the base station on the basis of the signal received by the data receiving means; master base station selecting means selecting, as a master base station, a base station whose distance between preliminarily given position information of the base station and the first positioning position of the base station lies in a predetermined range; master base station correction value calculating means generating a correction value of the master base station on the basis of a signal received from the satellite by the master base station; second positioning position calculating means calculating a second positioning position of a base station other than the master base station by correcting the first positioning position of the base station other than the master base station with the correction value of the master base station by the base station other than the master base station; and abnormality determining means determining that the base station other than the master base station is in an abnormal state when the distance between a position by preliminarily given position information of the base station other than the master base station and the second positioning position is larger than a first threshold.

A storage medium of the present invention is a storage medium storing a program for detecting an abnormal state of a base station in a positioning system having a satellite and the base station, including: a process of calculating a first positioning position of the base station on the basis of the signal received by the data receiving means; a process of selecting predetermined number of master base stations in ascending order of a distance between preliminarily given position information of the base station and the first positioning position of the base station; a process of generating a correction value of the master base station on the basis of a signal received from the satellite by the master base station; a second positioning position calculating process of calculating a second positioning position of a base station other than the master base station by correcting the first positioning position of the base station other than the master base station with the correction value of the master base station by the base station other than the master base station; and a process of determining that the base station other than the master base station is in an abnormal state when the distance between a position by preliminarily given position information of the base station other than the master base station and the second positioning position is larger than a first threshold.

A storage medium of the present invention is a storage medium storing a program for detecting an abnormal state of a base station in a positioning system having a satellite and the base station, including: a process of calculating a first positioning position of the base station on the basis of the signal received by the data receiving means; a process of selecting, as a master base station, a base station whose distance between preliminarily given position information of the base station and the first positioning position of the base station lies in a predetermined range; a process of generating a correction value of the master base station on the basis of a signal received from the satellite by the master base station; a second positioning position calculating process of calculating a second positioning position of a base station other than the master base station by correcting the first positioning position of the base station other than the master base station with the correction value of the master base station by the base station other than the master base station; and a process of determining that the base station other than the master base station is in an abnormal state when the distance between a position by preliminarily given position information of the base station other than the master base station and the second positioning position is larger than a first threshold.

### Advantageous Effects of Invention

According to the present invention, an abnormal state of a base station in a satellite positioning system can be detected with high precision.

### BRIEF DESCRIPTION OF DRAWINGS

FIG. 1 is a diagram illustrating an example of the configuration of a differential GPS according to a first exemplary embodiment of the present invention;

FIG. 2 is a flowchart illustrating an example of the procedure of a method of detecting a state of a base station in the differential GPS according to the first exemplary embodiment of the invention;

FIG. 3 is a diagram illustrating an example of the configuration of a correction value processing device according to the first exemplary embodiment of the invention;

FIG. 4 is a diagram illustrating an example of the configuration of a data processing unit according to a second exemplary embodiment of the present invention;

FIG. 5 is a flowchart illustrating an example of the procedure of a method of detecting a state of a base station in the differential GPS according to the second exemplary embodiment of the invention; and

FIG. 6 is a flowchart illustrating an example of the procedure of a method of detecting a state of a base station in a differential GPS according to a third exemplary embodiment of the present invention.

### DESCRIPTION OF EMBODIMENTS

Best modes for carrying out the invention will be described specifically with reference to the drawings. The present invention, however, is not limited to the following exemplary embodiments.

### First Exemplary Embodiment

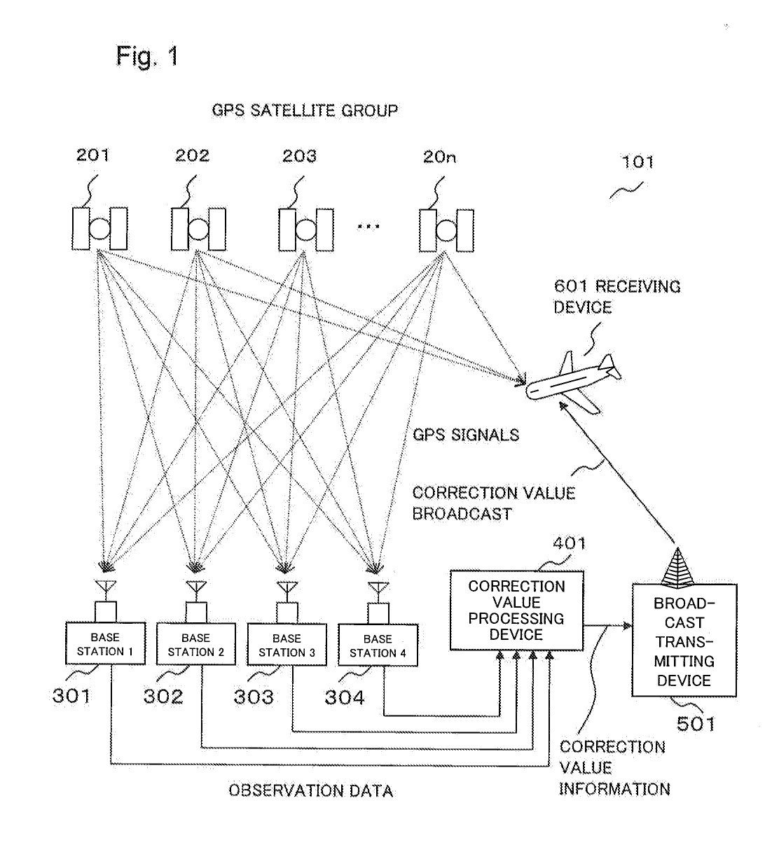

FIG. 1 illustrates an example of the configuration of a differential GPS 101 according to a first exemplary embodiment of the present invention.

A receiving device 601 receives GPS signals from GPS satellites 201 to 20n and estimates the position of itself. The receiving device 601 is mounted in, for example, an aircraft.

A plurality of base stations 301 to 304 receive GPS signals from the GPS satellites 201 to 20n and transmit observation data to a correction value processing device 401. The correction value processing device 401 receives the GPS signals from the GPS satellites 201 to 20n, calculates a correction value at the time of measuring the position, and transmits the correction value to a broadcast transmitting device 501.

The broadcast transmitting device is, for example, a VDB (VHF (Very High Frequency) Data Broadcast) transmitting device.

The receiving device 601 receives a correction value broadcast transmitted from the broadcast transmitting device 501, corrects the GPS signals received from the GPS satellites 201 to 20n, and estimates the position of itself.

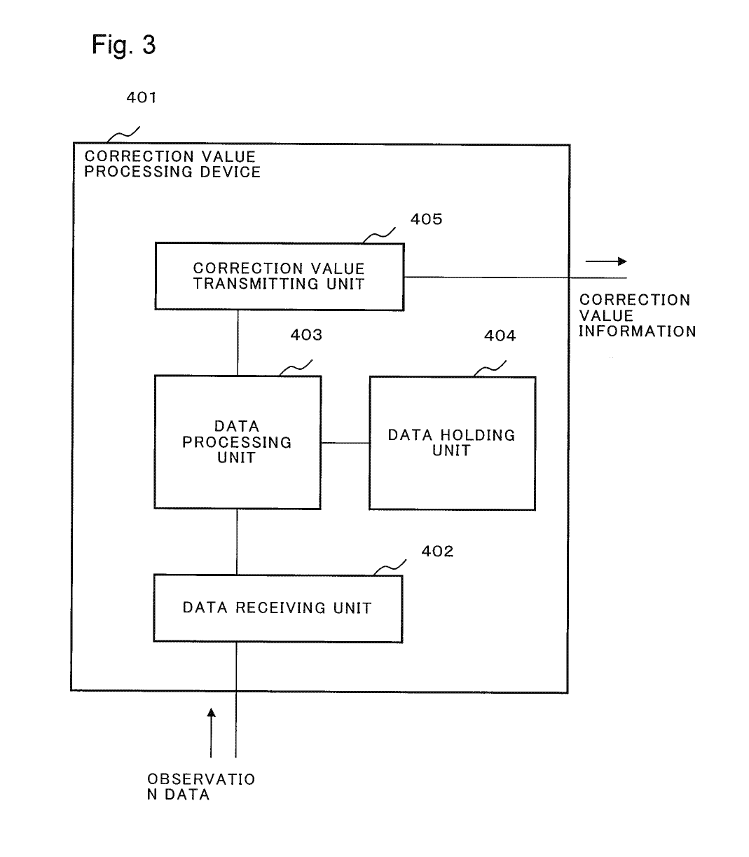

FIG. 3 illustrates an example of the configuration of the correction value processing device 401 according to the exemplary embodiment. The correction value processing device 401 has a data receiving unit 402 receiving observation data transmitted from the base stations 301 to 304, and a correction value transmitting unit 405 transmitting correction value information to the broadcast transmitting device 501 to provide it to the receiving device 601. The correction value processing device further has a data processing unit 403 processing the observation data received by the data receiving unit 402 to generate correction value information, and a data holding unit 404 holding data on the base stations 301 to 304. The data holding unit 404 also temporarily holds the information processed by the data processing unit 403 and holds values of parameters necessary for a testing process to be described below.

Next, the procedure of a method of detecting the state of a base station in the differential GPS according to the first exemplary embodiment of the present invention will be described with reference to FIGS. 1 to 3.

Although the number of base stations is four in the exemplary embodiment, the invention is not limited to the number. The number of base stations may be smaller than four or larger than four.

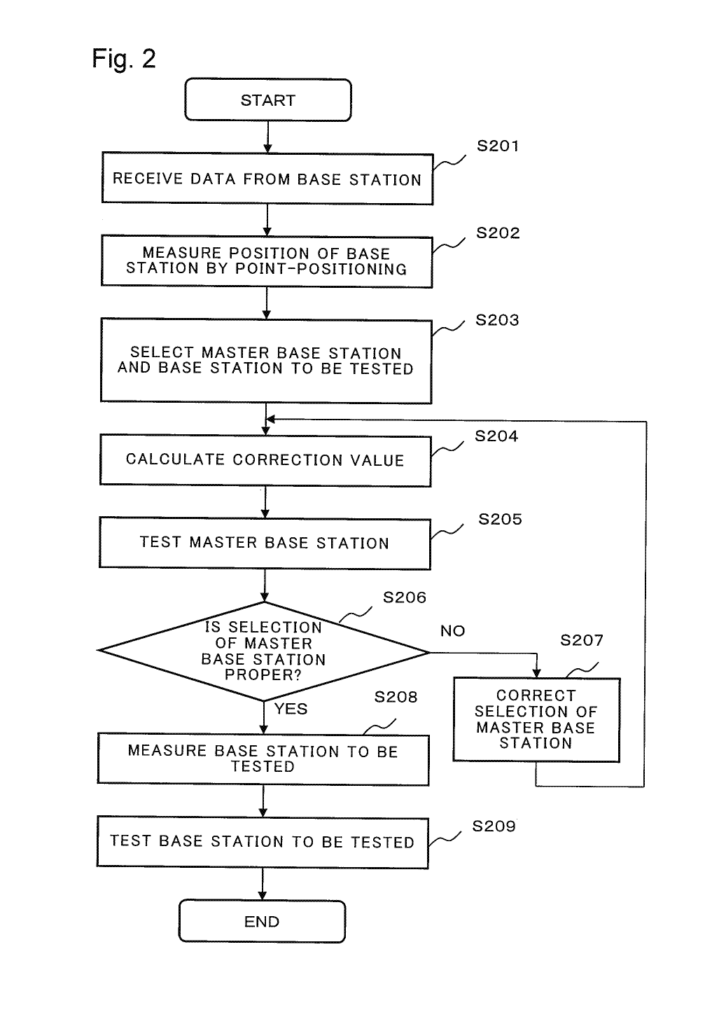

The correction value processing device 401 receives observation data from the base stations 301 to 304 which received the GPS signals generated from the GPS satellites 201 to 20n (step S201 in FIG. 2).

Next, the correction value processing device 401 measures the position of each of the base stations 301 to 304 on the basis of the observation data (point positioning) (step S202).

The point positioning is executed by using pseudo ranges from the four GPS satellites (distances from the GPS satellites to the receiver). The precision of the clock provided in the receiving device 601 is inferior to that of the atomic clock of the GPS satellite by a few digits. Even when the transmission time of the radio wave of the atomic clock in the GPS satellite is accurate, there is the possibility that a large error is included in reach time measured by the receiver. To determine four unknown amounts which are three-dimensional positions of receiving the radio wave from the GPS satellite and, in addition, the error of the clock of the receiving device 601, the pseudo ranges from the four or more GPS satellites are used at the same time.

The positioning position of a base station is obtained by the point positioning. To prevent variations in the precision of positioning among the base stations, at least one of the following conditions may be set.

(1) A satellite of a low elevation angle (for example, 10 degrees or less) is eliminated from positioning calculation to reduce a positioning error due to the influence of ionosphere and aerosphere or multipath.
(2) Only common satellites which are visible from all of the base stations are used for positioning calculation.
(3) Positioning calculation is performed by using the same clock/ephemeris (time/orbit) parameters to a given satellite. That is, clock/ephemeris parameters to be used are made the same to GPS signals transmitted from satellites.

Next, the correction value processing device 401 selects a master base station and a base station to be tested from the base stations 301 to 304 (step S203).

Three-dimensional coordinate values are preliminarily given as numerical values of high precision to each of the positions of the base stations fixed to the surface of the earth. Hereinbelow, the position will be called a measured position. The coordinate values on the measured position are held in the data holding unit 404 in the correction value processing device 401.

The difference between the positioning position and the measured position will be called a positioning error in the following. The positioning error is defined as a three-dimensional range. Those arithmetic operations are performed by the correction value processing device 401.

On each of the base stations, the positioning position obtained by the point positioning and the measured position are compared, and a base station having the smallest positioning error and a base station having the second smallest positioning error are selected. The base station having the smallest positioning error is set as a master base station A, and the base station having the second smallest positioning error is set as a master base station B.

Although two master base stations are selected in the exemplary embodiment, when the number of master base stations is large, three or more master base stations may be used.

A base station which is not selected as a master base station becomes a base station to be tested. In the exemplary embodiment, two base stations remain, so that they become base stations X and Y to be tested.

Next, on the basis of the observation data obtained from the master base stations and the values of the measured positions, the correction value processing device 401 calculates DGPS correction values in the master base stations (step S204). The DGPS correction value in the master base station A is a DGPS correction value A, and the DGPS correction value in the master base station B is a DGPS correction value B.

The DGPS correction value is obtained as follows.

The pseudo range measured by a base station includes an error from a true distance between the GPS satellite and the base station. The pseudo range also includes an error caused by an internal noise such as a clock bias of the base station (the difference between time displayed by the base station and true time) or a clock bias of the GPS satellite. Further, the pseudo range includes a troposphere delay amount the base station experiences, an ionosphere delay amount the base station experiences, a multipath the base station experiences, and errors caused by internal noises such as thermal noise the base station experiences.

A pseudo range correction value is defined as a value obtained by subtracting a pseudo range of a base station subjected to a smoothing process from a geometric distance between a GPS satellite and the base station, calculated from position information of the GPS satellite broadcasted by the GPS satellite and a position obtained by measuring the base station. The geometric distance between the GPS satellite and the base station is obtained by adding an error of the position information of the GPS satellite broadcasted by the GPS satellite and an error of a distance obtained by measuring the base station to the true distance between the GPS satellite and the base station.

The pseudo range correction value derived from the relational equation includes a clock bias of the satellite, a troposphere delay amount the satellite experiences, an ionosphere delay amount the satellite experiences, an error which is recognized as an error of the receiving device and can be separated, and other errors.

The pseudo range correction value by the base station obtained is applied to correction of the pseudo range of the receiving device. The pseudo range of the receiving device includes the true distance between the GPS satellite and the receiving device, an error component which can be separated in a process of positioning calculation as a clock bias of the receiving device, and an error component evaluated by using a standard deviation peculiar to each of observation amounts or assumed.

Actual pseudo range correction values are averaged by a plurality of base stations. By the operation, a random error by multipath propagation, noise of the receiving device, and the like is suppressed. On the other hand, the ionosphere delay amount and the troposphere delay amount are averaged and remain.

Subsequently, a test of selection of a master base station is executed (step S205). The two master base stations performs DGPS positioning by applying their DGPS correction values to each other, and the results of the positioning are compared with their measured positions. Since selection of the master base station depends on the point positioning as described above, regardless of the presence of abnormality, there is the possibility that the positioning error becomes small by chance. The test of the selection of the master base station eliminates this possibility.

When a base station operates normally, the positioning position obtained by the result of the point positioning reproduces the measured position of the base station with high precision. That is, in a base station with a large positioning error, a failure in the operation is suspected. It is feared that, by a correction value generated from a base station in which a failure occurs, a GPS signal is corrected to a direction deviated from a correct position. Inclusion of the correction value in the correction value information to be provided to the receiving device 601 becomes a cause of increase in an error.

A selection of a base station as a master base station because a positioning error is small in the point positioning by chance regardless of the fact that abnormality occurs in the base station and a DGPS correction value by the base station does not give a normal positioning result is not a proper selection. When the selection of a master base station is not proper as described above (NO in step S206), the correction value processing device 401 corrects the selection of the master base station (step S207) and calculates a correction value of a master base station newly selected (step S204).

When the selection of a master base station is proper (YES in step S206), the correction value processing device 401 applies the DGPS correction value of the master base station to a base station to be tested and performs a DGPS positioning (step S208).

Subsequently, a test on the base station to be tested is executed (step S209).

The difference between the DGPS positioning result of the base station to be tested and the positioning result of each of base stations is obtained. When the value of the difference exceeds a predetermined threshold with respect to the DGPS correction values of two master base stations, it is determined that the base station to be tested is abnormal. Table 1 illustrates the logic of pass/fail determination.

TABLE 1
Pass/fail determination logic

| | Determination | Determination | |
|---|---|---|---|
| | by DGPS | by DGPS | |
| | correction value | correction value | |
| | of master base | of master base | Overall |
| | station A | station B | determination |
| Base station X to | pass | pass | pass |
| be tested | pass | fail | pass |
| | fail | pass | pass |
| | fail | fail | fail |
| Base station Y to | pass | pass | pass |
| be tested | pass | fail | pass |
| | fail | pass | pass |
| | fail | fail | fail |

A threshold used for the determination may be changed according to precision of the positioning. For example, the threshold may be determined on the basis of PDOP (Position Dilution of Precision) in which a disposition state of a GPS satellite is reflected and the number of satellites for the following reason. In some cases, the PDOP changes according to increase/decrease of the number of satellites, and the positioning precision changes. There is consequently the possibility that, with a fixed threshold, the determination becomes inaccurate.

In comparison between a DGPS positioning result and a measured position, if the difference is disassembled into a vertical-direction component and a horizontal-direction component, the magnitude of an error cannot be accurately reflected. Therefore, evaluation is performed on the basis of a distance in three dimensions. To a testing process based on the three-dimensional distance, the Maxwell-Boltzmann distribution is applied.

In operation of the GBAS, to GPS signals from one GPS satellite, DGPS correction values from a plurality of base stations are averaged for the base stations. An obtained average value is supplied to a receiving device. By averaging DGPS correction values from a plurality of base stations operating normally and providing an average value to a receiving device, variations in the base stations are suppressed, and the receiving device can measure the position of itself with higher precision.

The data processing unit 403 in the correction value processing device 401 generates correction value information by excluding observation data from a base station to be tested which was determined as “fail” as a result of the test. The correction value transmitting unit 405 transmits the correction value information to the broadcast transmitting device 501.

Next, the process of data in the correction value processing device 401 will be described specifically.

First, the correction value processing device 401 performs point positioning on the base stations 301 to 304. As described above, a GPS signal from a GPS satellite which may cause an error in positioning is excluded. For the point positioning, GPS signals from n pieces of GPS satellites 201 to 20n are used. Three-dimensional coordinate values of a positioning position of a base station obtained by the point positioning are described as follows.

Base station 301: (xₛₐ₁, yₛₐ₁, zₛₐ₁)
Base station 302: (xₛₐ₂, yₛₐ₂, zₛₐ₂)
Base station 303: (xₛₐ₃, yₛₐ₃, zₛₐ₃)
Base station 304: (xₛₐ₄, yₛₐ₄, zₛₐ₄)

The three-dimensional coordinate values of the measured positions for the base stations 301 to 304 are described as follows.

Base station 301: (x₁, y₁, z₁)
Base station 302: (x₂, y₂, z₂)
Base station 303: (x₃, y₃, z₃)
Base station 304: (x₄, y₄, z₄)

From the coordinate values, the difference between the point positioning position and the measured position on each of the base stations 301 to 304 is obtained as a three-dimensional distance.

Base station 301: Δₛₐ₁=√(xₛₐ₁−x₁)²+(yₛₐ₁−y₁)²+(zₛₐ₁−z₁)²)
Base station 302: Δₛₐ₂=√(xₛₐ₂−x₂)²+(yₛₐ₂−y₂)²+(zₛₐ₂−z₂)²)
Base station 303: Δₛₐ₃=√(xₛₐ₃−x₃)²+(yₛₐ₃−y₃)²+(zₛₐ₃−z₃)²)
Base station 304: Δₛₐ₄=√(xₛₐ₄−x₄)²+(yₛₐ₄−y₄)²+(zₛₐ₄−z₄)²)

The small/large relations are examined on the differences obtained by the above process. In the exemplary embodiment, it is assumed that, for example, the following small/large relations are obtained.

Δₛₐ₃>Δₛₐ₁>Δₛₐ₄>Δₛₐ₂

That is, it is assumed that the difference between the point positioning position and the measured position on the base station 303 is the largest and the difference on the base station 302 is the smallest.

On the basis of the small/large relations, the base station giving the smallest difference and the base station giving the second smallest difference become master base stations. Specifically, the base station 302 becomes the master base station A, and the base station 304 becomes the master base station B. A base station giving a larger difference than these base stations is set as a base station to be tested. In the exemplary embodiment, the base station 303 becomes a base station X to be tested, and the base station 301 becomes a base station Y to be tested.

Subsequently, a DGPS correction value in the master base station is obtained.

On the basis of the GPS signals from the n pieces of GPS satellites 201 to 20n used for the point positioning, the DGPS correction values obtained in the master base stations are described as follows.

Positioning position by C_{A} of base station X to be tested: (x_{dgpsXA}, y_{dgpsXA}, z_{dgpsXA})
Positioning position by C_{B} of base station X to be tested: (x_{dgpsXB}, y_{dgpsXB}, z_{dgpsXB})
Positioning position by C_{A} of base station Y to be tested: (x_{dgpsYA}, y_{dgpsYA}, z_{dgpsYA})
Positioning position by C_{B} of base station Y to be tested: (x_{dgpsYB}, y_{dgpsYB}, z_{dgpsYB})

The obtained coordinate values are used for a test of a base station described below.

Similarly, the master base stations A and B apply their DGPS correction values to each other and execute DGPS positioning to each other.

The obtained positioning positions are described as follows.

Positioning position by C_{B} of master base station A: (x_{dgpsAB}, y_{dgpsAB}, z_{dgpsAB})
Positioning position by C_{A} of master base station B: (x_{dgpsBA}, y_{dgpsBA}, z_{dgpsBA})

The difference between the obtained positioning position and the measured position is obtained as a three-dimensional distance.

### On Master Base Station A

Δ_{dgpsA}=√((x_{dgpsAB}−x₂)²+(y_{dgpsAB}−y₂)²+(z_{dgpsAB}−z₂)²)

### On Master Base Station B

Δ_{dgpsB}=√((x_{dgpsBA}−x₄)²+(y_{dgpsBA}−y₄)²+(z_{dgpsBA}−z₄)²)

Next, using the obtained results, a test on a master base station is executed.

The difference between the positioning position and the measured position on the master base station obtained by the above process is compared with a predetermined threshold THₘₐₛₜₑᵣ.

### Master Base Station A

When Δ_{dgpsA}<THₘₐₛₜₑᵣ, the master base station A passes the test.

### Master Base Station B

When Δ_{dgpsB}<THₘₐₛₜₑᵣ, the master base station B passes the test.

The threshold THₘₐₛₜₑᵣ may be properly determined so as to reflect the precision of the positioning. For example, it may be determined on the basis of the PDOP (Position Dilution of Precision) reflecting the disposition state of the GPS satellite and the number of GPS satellites.

It is assumed now that “r” is an amount which is made non-dimensional by dividing a system for the three-dimensional error by typical length. In this case, with reference to the Maxwell-Boltzmann distribution as a probability distribution function on “r” expressed by the following equation (1), the threshold THₘₐₛₜₑᵣ may be determined on the basis of maximum allowable false-alarm probability, maximum allowable detection failure probability, standard deviation of an error at fault-free time, or the like.

In the case where a master base station fails the test, to select a proper master base station, the failed master base station and the base station to be tested are replaced. Since selection of a master base station is based on a result of the point positioning, the operation is a process of eliminating the possibility that the difference between the point positioning and the measured position becomes small by chance.

When any one of the master base stations fails the test, the failed master base station and a base station to be tested having the smallest difference between a result of point positioning and a measured position among base stations to be tested are replaced.

When both of the master base stations fail the test, both of the master base stations and two base stations to be tested are replaced. Although the exemplary embodiment relates to the configuration of the DGPS including the four master base stations, in the case where the number of master base stations is larger than four, the base station to be tested having the smallest difference between the result of point positioning and the measured position and the base station to be tested having the next smallest difference are replaced with the two master base stations.

After replacing the master base stations, the DGPS correction value in each of the master base stations is calculated, and the above-described process is repeated.

In the case where a failure occurs in a base station and observation data includes an error, a DGPS correction value calculated based on the observation data also includes an error. Consequently, for example, when a failure occurs in the master base station A, C_{A} as a DGPS correction value by the master base station A also includes an error. In a positioning position by C_{B} of the master base station A, an error included in observation data from the master base station A is reflected. In a positioning position by C_{A} of the master base station B, an error included in the DGPS correction value C_{A} by the master base station A is reflected.

Therefore, in the case where the master base station A fails the test, the master base station A is replaced with one of base stations to be tested, the test process is performed, and the master base station fails again the test, the master base station A may be taken back, and the master base station B may be replaced.

Similarly, also in the case where both of the master base stations fail, there is the possibility that a failure occurs only in one of the master base stations, so that any one of the master base stations may be taken back depending on a result of the test process after replacing the master base stations.

Subsequently, the difference between the DGPS positioning result and the measured position in a base station to be tested is calculated as a three-dimensional distance.

The difference between positioning position by C_{A} of the base station X to be tested and measured position

Δ_{dgpsXA}=√((x_{dgpsXA}−x₃)²+(y_{dgpsXA}−y₃)²+(z_{dgpsXA}−z₃)²)

The difference between positioning position by C_{B} of the base station X to be tested and measured position

Δ_{dgpsXB}=√((x_{dgpsXB}−x₃)²+(y_{dgpsXB}−y₃)²−(z_{dgpsXB}−z₃)²)

The difference between positioning position by C_{A} of the base station Y to be tested and measured position

Δ_{dgpsYA}=√((x_{dgpsYA}−x₁)²+(y_{dgpsYA}−y₁)²+(z_{dgpsYA}−z₁)²)

The difference between positioning position by C_{A} of the base station X to be tested and measured position

Δ_{dgpsYB}=√((x_{dgpsYB}−x₁)²+(y_{dgpsYB}−y₁)²+(z_{dgpsYB}−z₁)²)

By using these differences, a test on a base station to be tested is executed.

When (Δ_{dgpsXA}<THₜₑₛₜ) and (Δ_{dgpsXB}<THₜₑₛₜ) are satisfied, the base station X to be tested fails. In the other case, the base station X to be tested passes the test.

When (Δ_{dgpsYA}<THₜₑₛₜ) and (Δ_{dgpsYB}<THₜₑₛₜ) are satisfied, the base station Y to be tested fails. In the other case, the base station Y to be tested passes the test.

The threshold THₜₑₛₜ, like THₘₐₛₜₑᵣ, may be properly determined so as to reflect the precision of the positioning. For example, it may be determined on the basis of the PDOP (Position Dilution of Precision) reflecting the disposition state of the GPS satellite and the number of GPS satellites. It is assumed now that “r” is an amount which is made non-dimensional by dividing a system for the three-dimensional error by typical length. In this case, with reference to the Maxwell-Boltzmann distribution as a probability distribution function on “r”, the threshold THₜₑₛₜ may be determined on the basis of maximum allowable false-alarm probability, maximum allowable detection failure probability, standard deviation of an error at fault-free time, or the like.

As a result of the process, correction value information transmitted from the correction value processing device 401 to the broadcast transmitting device 501 includes a DGPS correction value of a base station which passed the test.

According to the method of detecting the state of a base station in a differential GPS according to the exemplary embodiment, a GPS signal is received from a GPS satellite, and occurrence of an abnormal state of a base station correcting the GPS signal on the basis of the position information of itself can be detected with high precision. That is, by testing the master base station itself, a base station referred to can be trusted as a base station operating normally. Consequently, based on observation data from the base station determined to operate normally, an abnormal state of a base station having the possibility of occurrence of abnormality can be detected. Therefore, even when abnormality occurs in a plurality of base stations, the abnormal state can be detected with high precision. There is also no possibility that occurrence of abnormality in a base station which is operating normally is determined erroneously.

By setting a threshold in consideration of the number and disposition of GPS satellites, the state is abnormal or normal can be determined with higher precision.

Although an abnormal state of a base station is detected by using correction value information in a differential GPS in the exemplary embodiment of the invention, the invention is not limited to the case.

The present invention is preferably applied, in a positioning system of receiving a signal from a signal source which periodically generates information of time and position of itself and estimating the position of the system itself, to detection of an abnormal state of a fixed base station, which is referred to in a process of generating correction information for the signal.

Although the example of mounting the receiving device in an aircraft was described in the exemplary embodiment, the invention is not limited to the exemplary embodiment. The receiving device may be mounted in a ship or held by a car or a pedestrian. Although correction value information is provided as VHF airwaves to the receiving device in the exemplary embodiment, the invention is not limited to the exemplary embodiment. The correction value information may be transmitted by radio waves in other frequency bands or by wire. Further, the present invention can be also applied to a positioning system in water.

An apparatus executing the processing operation may be configured by storing a program for executing the processing operation in a computer-readable recording medium, distributing it, and installing the program into a computer. Examples of the computer-readable recording medium include a flexible disk, a CD-ROM (Compact Disk Read-Only Memory), and MO (Magneto-Optical disk).

### Second Exemplary Embodiment

A second exemplary embodiment of the present invention will be described with reference to the drawings.

The configuration of the differential GPS 101 in the second exemplary embodiment of the present invention is similar to the example of the configuration of the differential GPS 101 in the first exemplary embodiment illustrated in FIG. 1. A configuration example of the correction value processing device 401 in the second exemplary embodiment of the present invention is also similar to that of the correction value processing device 401 in the first exemplary embodiment illustrated in FIG. 3.

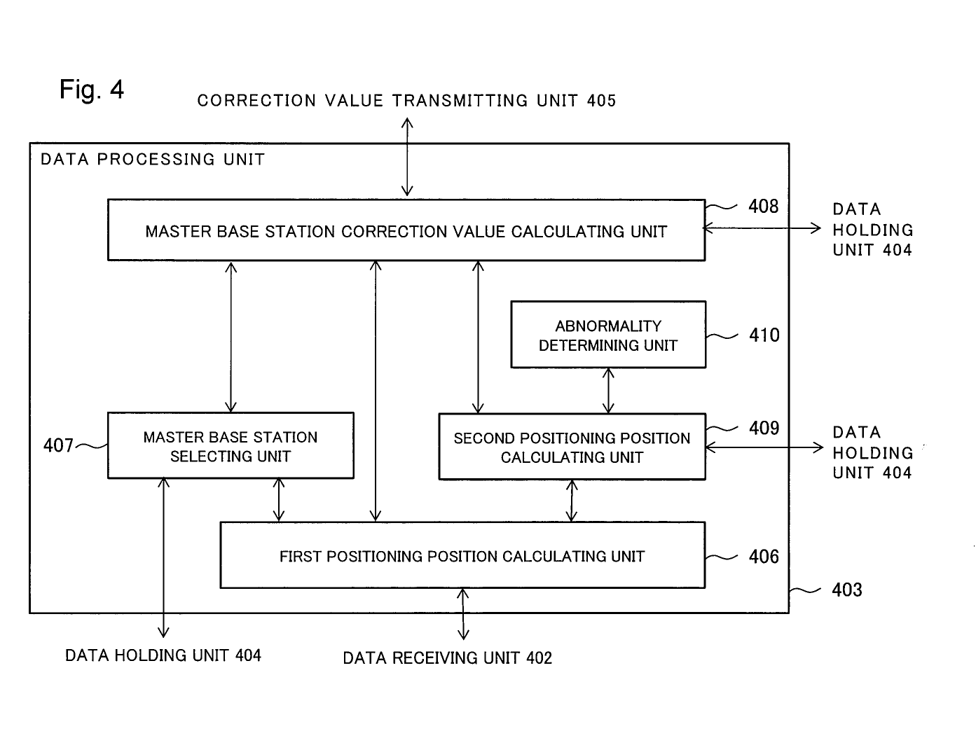

FIG. 4 is a diagram illustrating a configuration example of the data processing unit 403 included in the correction value processing device 401 in the second exemplary embodiment of the invention.

The data processing unit 403 includes a first positioning position calculating unit 406, a master base station selecting unit 407, a master base station correction value calculating unit 408, a second positioning position calculating unit 409, and an abnormality determining unit 410.

The first positioning position calculating unit 406 obtains a first positioning position of a base station on the basis of a signal received from a satellite by the base station. The first positioning position calculating unit 406 performs point positioning on the base stations 301 to 304. As described in the first exemplary embodiment, the first positioning position calculating unit 406 uses, as point positioning, GPS signals from the n pieces of the GPS satellites 201 to 20n and obtains three-dimensional coordinate values of the positioning positions of the base stations 301 to 304.

The master base station selecting unit 407 selects predetermined number of master base stations in ascending order of the distance between preliminarily given position information (measured position) of a base station and a first positioning position obtained by the first positioning position calculating unit 406. As described in the first exemplary embodiment, the master base station selecting unit 407 obtains, as a three-dimensional distance, the difference between the positioning position and the measured position on each of the base stations 301 to 304 and calculates the small/large relations on the differences. On the basis of the calculated small/large relations, the master base station selecting unit 407 selects, as master base stations, for example, the base station having the smallest difference and the base station having the next smallest difference.

On the basis of a signal received from a satellite by a master base station, the master base station correction value calculating unit 408 generates a correction value of the master base station. The correction value of the master base station is, for example, a DGPS correction value in the first exemplary embodiment.

Base stations other than the master base stations correct the first positioning position of the base stations other than the master base stations by the correction value of the master base station, and the second positioning position calculating unit 409 obtains a second positioning position of a base station other than the master base station. The second positioning position calculating unit 409 applies the correction value of each of the master base stations to the first positioning position of the base station other than the master base stations, thereby obtaining the second positioning position. That is, the second positioning position calculating unit 409 obtains second positioning positions only by the number of master base stations.

When the distance between the position according to preliminarily given position information of a base station other than the master base stations and the second positioning position is larger than the first threshold, the abnormality determining unit 410 determines that the base station other than the master base stations is in an abnormal state. The determination by the abnormality determining unit 401 that a base station other than the master base station is in an abnormal state is performed, for example, on the basis of the pass/fail determination logic in Table 1 in the first exemplary embodiment.

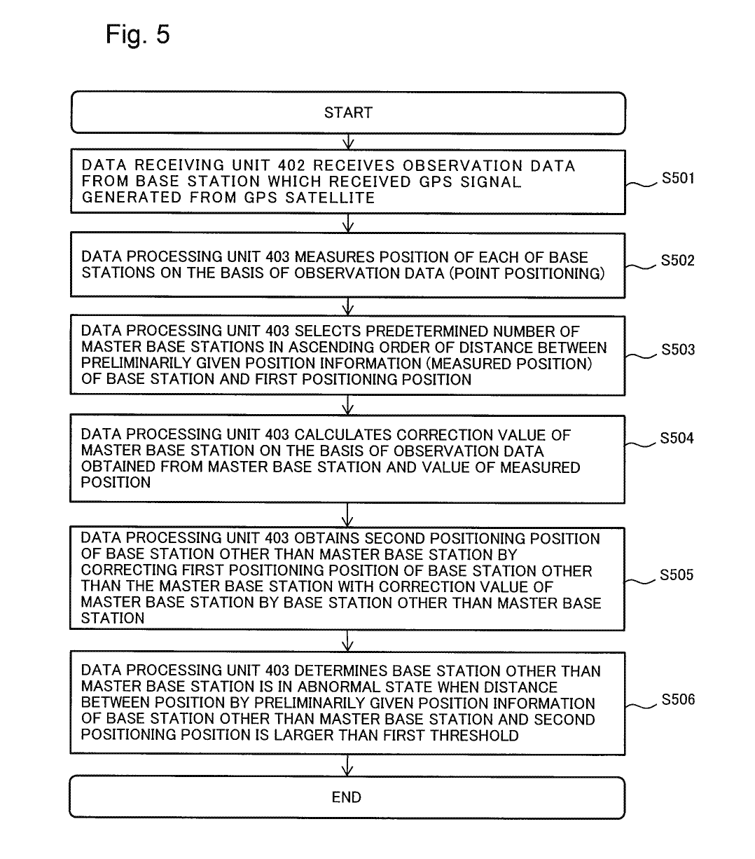

FIG. 5 is a flowchart illustrating an operation example of the correction value processing device 401 in the second exemplary embodiment of the present invention.

The data receiving unit 402 in the correction value processing device 401 receives observation data from the base stations 301 to 304 which received the GPS signals generated from the GPS satellites 201 to 20n (step S501).

Next, the data processing unit 403 in the correction value processing device 401 measures the position of each of the base stations 301 to 304 on the basis of the observation data (point positioning) to obtain a first positioning distance (step S502).

The data processing unit 403 selects predetermined number of master base stations in ascending order of the distance between position information which is preliminarily given of the base station (measured position) and the first positioning position (step S503).

On the basis of the observation data obtained from the master base station and the value of the measured position, the data processing unit 403 calculates the correction value of the master base station (step S504).

Base stations other than the master base stations correct the first positioning position of the base stations other than the master base stations by the correction value of the master base station and, thereby obtaining a second positioning position of a base station other than the master base station by the data processing unit 403 (step S505).

When the distance between the position according to preliminarily given position information of a base station other than the master base stations and the second positioning position is larger than the first threshold, the data processing unit 403 determines that the base station other than the master base stations is in an abnormal state (step S506).

According to the method of detecting a state of a base station in a differential GPS according to the exemplary embodiment, a GPS signal is received from a GPS satellite and occurrence of an abnormal state of a base station which corrects the GPS signal on the basis of position information of itself can be detected.

In the state detecting method, by setting a threshold in consideration of the number and disposition of GPS satellites, whether a base station is abnormal or normal can be determined with high precision.

### Third Exemplary Embodiment

A third exemplary embodiment of the present invention will be described with reference to the drawings.

In the third exemplary embodiment of the present invention, a base station is set as a master base station when the distance between preliminarily given position information (measured position) of the base station and a first positioning position of the base station lies in a predetermined range. That is, in the third exemplary embodiment of the invention, by using the absolute value of the distance between the measured position of a base station and the first positioning position of the base station, a master base station is selected.

The configuration of the differential GPS 101 in the third exemplary embodiment of the present invention is similar to the example of the configuration of the differential GPS 101 in the first exemplary embodiment illustrated in FIG. 1. A configuration example of the correction value processing device 401 in the third exemplary embodiment of the present invention is also similar to that of the correction value processing device 401 in the first exemplary embodiment illustrated in FIG. 3. Further, a configuration example of the correction value processing device 401 in the third exemplary embodiment of the invention is similar to that of the data processing unit 403 in the second exemplary embodiment illustrated in FIG. 4.

In the third exemplary embodiment of the present invention, the master base station selecting unit 407 selects, as a master base station, a base station when the distance between preliminarily given position information (measured position) of the base station and a first positioning position of the base station lies in a predetermined range.

Three-dimensional coordinate values of the first positioning position of a base station obtained by point positioning are described as follows.

Base station 301: (xₛₐ₁, yₛₐ₁, zₛₐ₁)
Base station 302: (xₛₐ₂, yₛₐ₂, zₛₐ₂)
Base station 303: (xₛₐ₃, yₛₐ₃, zₛₐ₃)
Base station 304: (xₛₐ₄, yₛₐ₄, zₛₐ₄)

The three-dimensional coordinate values of the measured positions for the base stations 301 to 304 are described as follows.

Base station 301: (x₁, y₁, z₁)
Base station 302: (x₂, y₂, z₂)
Base station 303: (x₃, y₃, z₃)
Base station 304: (x₄, y₄, z₄)

From the coordinate values, the master base station selecting unit 407 obtains, as the third-dimensional distance, the distance between the first positioning position and the measured position on each of the base stations 301 to 304.

Base station 301: Δₛₐ₁=√(xₛₐ₁−x₁)²+(yₛₐ₁−y₁)²+(zₛₐ₁−z₁)²)
Base station 302: Δₛₐ₂=√(xₛₐ₂−x₂)²+(yₛₐ₂−y₂)²+(zₛₐ₂−z₂)²)
Base station 303: Δₛₐ₃=√(xₛₐ₃−x₃)²+(yₛₐ₃−y₃)²+(zₛₐ₃−z₃)²)
Base station 304: Δₛₐ₄=√(xₛₐ₄−x₄)²+(yₛₐ₄−y₄)²+(zₛₐ₄−z₄)²)

After that, the master base station selecting unit 407 determines whether each of the distances Δₛₐ₁, Δₛₐ₂, Δₛₐ₃, and Δₛₐ₄ between the first positioning position obtained and the measured position lies in a predetermined threshold (predetermined range) or not.

The master base station selecting unit 407 selects, as a master base station, a base station corresponding to Δₛₐ₁, Δₛₐ₂, Δₛₐ₃, or Δₛₐ₄ which is equal to or less than the predetermined threshold as a result of the determination. For example, when Δₛₐ₁ as the distance of the base station 301 and Δₛₐ₂ as the distance of the base station 302 lie in the predetermined range, the master base station selecting unit 407 selects the base stations 301 and 302 as master base stations.

In the case where there is no “distance” equal to or less than the predetermined threshold (predetermined range) in Δₛₐ₁, Δₛₐ₂, Δₛₐ₃, and Δₛₐ₄ as a result of the determination, the master base station selecting unit 407 may increase the predetermined threshold (expand the predetermined range) and perform the determination again. In this case, the master base station selecting unit 407 may increase the predetermined threshold (expand the predetermined range) each time the determination is performed and repeatedly execute the determination until the master base station can be selected.

In the case where there is no “distance” equal to or less than the predetermined threshold (predetermined range) in Δₛₐ₁, Δₛₐ₂, Δₛₐ₃, and Δₛₐ₄ as a result of the determination, the master base station selecting unit 407 may select a master base station on the basis of the small/large relations of the distance between the first positioning position and the measured position in a manner similar to the first exemplary embodiment.

In the case where there is no “distance” equal to or less than the predetermined threshold (predetermined range) in Δₛₐ₁, Δₛₐ₂, Δₛₐ₃, and Δₛₐ₄ as a result of the determination, the master base station selecting unit 407 may not select a master base station. In this case, without executing the following process, the correction value processing device 401 may finish the process.

On the other hand, when all of Δₛₐ₁, Δₛₐ₂, Δₛₐ₃, and Δₛₐ₄ are equal to or less than the predetermined threshold (predetermined range) as a result of the determination, the master base station selecting unit 407 may decrease the predetermined threshold (narrow the predetermined range) and perform the determination again. In this case, the master base station selecting unit 407 may decrease the predetermined threshold (narrow the predetermined range) each time the determination is performed and repeatedly execute the determination until a base station other than the master base station comes to exist.

In the case where all of Δₛₐ₁, Δₛₐ₂, Δₛₐ₃, and Δₛₐ₄ are equal to or less than the predetermined threshold (predetermined range) as a result of the determination, the master base station selecting unit 407 may select a master base station on the basis of the small/large relations of the distance between the first positioning position and the measured position in a manner similar to the first exemplary embodiment.

In the case where all of Δₛₐ₁, Δₛₐ₂, Δₛₐ₃, and Δₛₐ₄ are equal to or less than the predetermined threshold (predetermined range) as a result of the determination, the master base station selecting unit 407 may select all of the base stations as master base stations. In this case, the correction value processing device 401 does not execute a process of determining whether a base station other than the master base stations is in an abnormal state or not.

In the master base station selecting unit 407, the predetermined range as a condition for selecting a base station as a master base station can be changed according to, for example, a request of the user (such as an administrator). In this case, the user (such as an administrator) can adjust a condition of selecting a master base station by setting the predetermined range in consideration of the number or disposition of base stations. In the case where the predetermined range is set wide, even a base station whose distance between the first positioning position and the measured position is long to a certain extent is selected as a master base station. In this case, a correction value of the master base station becomes large and, as a result, a correction amount of the first positioning position of a base station other than the master base station also becomes large. The second positioning position of a base station other than the master base station is a value obtained by correcting the first positioning position of the base station other than the master base station by the correction value of the master base station. That is, when the correction value of the master base station is large, the second positioning position of a base station other than the master base station becomes a value obtained by largely correcting the first positioning position.

When the first positioning position is corrected largely, the correction amount of an error in DGPS positioning becomes large, so that the first positioning position becomes close to the measured position. Therefore, the possibility that the distance between the measured position of a base station other than a master base station and the second positioning position becomes larger than the first threshold decreases.

The abnormality determining unit 410 performs determination, for example, on the basis of the pass/fail determination logic of Table 1 in the first exemplary embodiment. In this case, when a base station passes in determination with a correction value in one master base station, the abnormality determining unit 410 determines that the base station passes in overall determination. Therefore, when a base station whose distance between the first positioning position and the measured position is long to a certain degree is selected as a master base station, the correction value becomes large, and the case that the abnormality determining unit 410 determines that a base station other than the master base station passes increases. As a result, the number of base stations other than master base stations determined by the abnormality determining unit 410 that they are in an abnormal state decreases. In other words, by widening the predetermined range, when an error is small to a certain degree, the abnormal state determining unit 410 determines that base stations other than a master base station are normal.

On the other hand, in the case of setting the predetermined range narrow, a base station whose distance between the first positioning position and the measured position is short is selected as a master base station. As a result, the number of base stations other than master base stations determined by the abnormality determining unit 410 that they are in an abnormal state increases. In other words, by narrowing the predetermined range, even if an error is small, the abnormality determining unit 410 determines that base stations other than a master base station are abnormal.

That is, in the third exemplary embodiment of the present invention, by changing the predetermined range as a condition for selecting a base station as a master base station, the precision of determination of whether a base station other than a master base station is abnormal or normal can be flexibly adjusted.

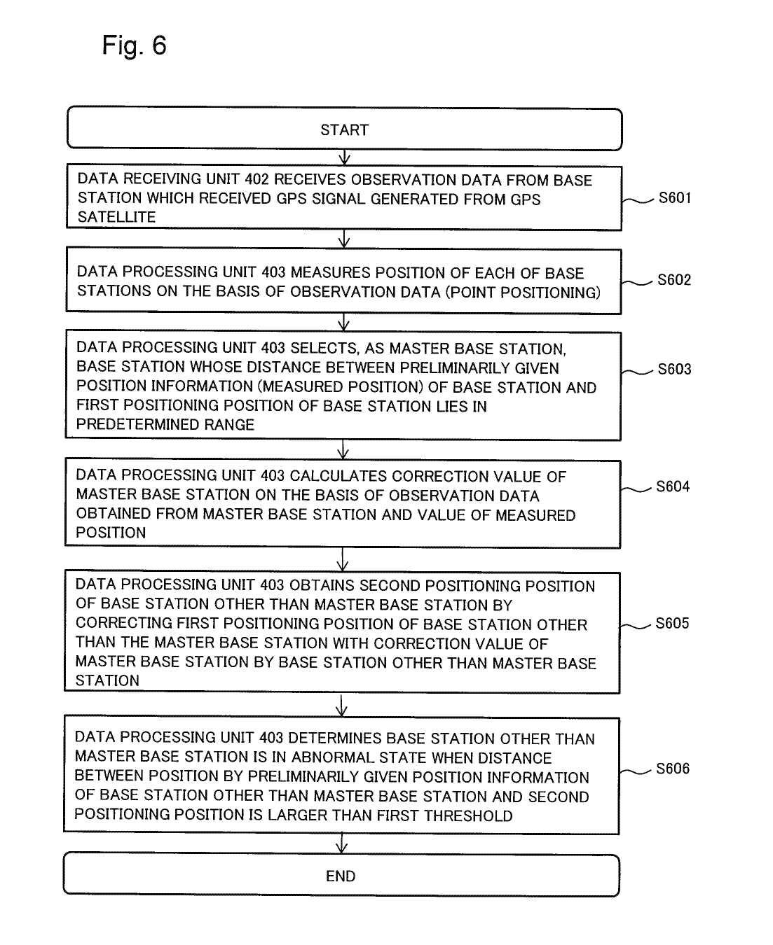

FIG. 6 is a flowchart illustrating an operation example of the correction value processing device 401 in the third exemplary embodiment of the present invention.

The data receiving unit 402 in the correction value processing device 401 receives observation data from the base stations 301 to 304 which received GPS signals generated from the GPS satellites 201 to 20n (step S601).

On the basis of the observation data, the data processing unit 403 in the correction value processing device 401 measures the position of each of the base stations 301 to 304 (point positioning) to obtain a first positioning distance (step S602).

Subsequently, the data processing unit 403 selects, as a master base station, a base station when the distance between preliminarily given position information (measured position) of the base station and the first positioning position of the base station lies in a predetermined range from the base stations 301 to 304 (step S603).

On the basis of the observation data and the value of the measured position obtained from the master base station, the data processing unit 403 calculates the correction value of the master base station (step S604).

In the data processing unit 403, a base station other than a master base station corrects the first positioning position of the base station other than the master base station by the correction value of the master base station, thereby obtaining a second positioning position of the base station other than the master base station (step S605).

When the distance between the position by preliminarily given position information of a base station other than a master base station and the second positioning position is larger than a first threshold, the data processing unit 403 determines that the base station other than the master base station is in an abnormal state (step S606).

As described above, in the state detecting method of the third exemplary embodiment of the present invention, a base station is determined as a master base station when the distance between preliminarily given position information (measured position) of the base station and a first positioning position of the base station lies in a predetermined range. In the state detecting method, by setting the predetermined range in consideration of the number and disposition of base stations, a condition of selecting a master base station can be adjusted. As a result, in the state detecting method, the precision of determination of whether a base station other than the master base station is abnormal or normal can be changed flexibly.

Although a part or all of the foregoing exemplary embodiments can be also described as the following supplementary notes, the present invention is not limited to the below.

### <Supplementary Note 1>

A state detecting method of detecting an abnormal state of a base station in a positioning system having a satellite and a base station, including:

obtaining a first positioning position of the base station on the basis of a signal received from the satellite by the base station;

selecting predetermined number of master base stations in ascending order of a distance between preliminarily given position information of the base station and the first positioning position of the base station;

generating a correction value of the master base station on the basis of a signal received from the satellite by the master base station;

obtaining a second positioning position of a base station other than the master base station by correcting the first positioning position of the base station other than the master base station with the correction value of the master base station by the base station other than the master base station; and

determining that the base station other than the master base station is in an abnormal state when the distance between a position by preliminarily given position information of the base station other than the master base station and the second positioning position is larger than a first threshold.

### <Supplementary Note 2>

A state detecting method of detecting an abnormal state of a plurality of base stations in a positioning system having a satellite and the plurality of base stations, including

obtaining a first positioning position of the base station on the basis of a signal received from the satellite by the base station;

selecting, as a master base station, a base station whose distance between preliminarily given position information of the base station and the first positioning position of the base station lies in a predetermined range;

generating a correction value of the master base station on the basis of a signal received from the satellite by the master base station;

obtaining a second positioning position of a base station other than the master base station by correcting the first positioning position of the base station other than the master base station with the correction value of the master base station by the base station other than the master base station; and

determining that the base station other than the master base station is in an abnormal state when the distance between a position by preliminarily given position information of the base station other than the master base station and the second positioning position is larger than a first threshold.

### <Supplementary Note 3>

The state detecting method described in the supplementary note 1 or 2, wherein the correction value of the master base station includes an ionosphere delay amount and a troposphere delay amount for the master base station.

### <Supplementary Note 4>

The state detecting method described in any of the supplementary notes 1 to 3, wherein a correction value of the master base station is a value obtained by subtracting the first positioning position obtained by executing a smoothing process on the pseudo range between the master base station and the satellite from the preliminarily given position of the master base station.

### <Supplementary Note 5>

The state detecting method described in any of the supplementary notes 1 to 4, wherein the positioning system includes the plurality of master base stations,

wherein the correction value used to correct the pseudo range of a base station other than the mater base station is an average value of the correction values generated by the plurality of master base stations.

### <Supplementary Note 6>

The state detecting method described in any of the supplementary notes 1 to 5, wherein the positioning system has a first master base station and a second master base station,

wherein a second positioning position of the first master base station is obtained, which is derived by correcting a pseudo range between the first master base station and the satellite obtained on the basis of a signal received from the satellite by the first master base station with a correction value of the second master base station;

when the distance between a position by preliminarily given position information of the first master base station and the second positioning position of the first master base station is larger than a second threshold, it is determined that the first master base station is in an abnormal state; and

when it is determined that the first master base station is in an abnormal state, one of base stations other than the plurality of master base stations is selected as the first master base station.

### <Supplementary Note 7>

The state detecting method described in any of the supplementary notes 1 to 6, wherein a satellite transmitting a signal to be received is selected from the plurality of satellites.

### <Supplementary Note 8>

The state detecting method described in the supplementary note 7, wherein as the satellite transmitting the signal to be received, a satellite whose elevation angle is larger than a predetermined angle or a satellite which can be seen from all of base stations included in the positioning system is selected from the plurality of satellites.

### <Supplementary Note 9>

The state detecting method described in any of the supplementary nodes 1 to 8, wherein the first threshold is determined with reference to a predetermined probability distribution function.

### <Supplementary Note 10>

The state detecting method described in any of the supplementary notes 1 to 9, wherein the first threshold is determined on the basis of the number of the satellites and a disposition state of the satellites.

### <Supplementary Note 11>

A correction value processing device including:

data receiving means receiving a signal received from a satellite by a base station;

first positioning position calculating means calculating a first positioning position of the base station on the basis of the signal received by the data receiving means;

master base station selecting means selecting predetermined number of master base stations in ascending order of a distance between preliminarily given position information of the base station and the first positioning position of the base station;

master base station correction value calculating means generating a correction value of the master base station on the basis of a signal received from the satellite by the master base station;

second positioning position calculating means calculating a second positioning position of a base station other than the master base station by correcting the first positioning position of the base station other than the master base station with the correction value of the master base station by the base station other than the master base station; and

abnormality determining means determining that the base station other than the master base station is in an abnormal state when the distance between a position by preliminarily given position information of the base station other than the master base station and the second positioning position is larger than a first threshold.

### <Supplementary Note 12>

A correction value processing device including:

data receiving means receiving a signal received from a satellite by a base station;

first positioning position calculating means calculating a first positioning position of the base station on the basis of the signal received by the data receiving means;

master base station selecting means selecting, as a master base station, a base station whose distance between preliminarily given position information of the base station and the first positioning position of the base station lies in a predetermined range;

master base station correction value calculating means generating a correction value of the master base station on the basis of a signal received from the satellite by the master base station;

second positioning position calculating means calculating a second positioning position of a base station other than the master base station by correcting the first positioning position of the base station other than the master base station with the correction value of the master base station by the base station other than the master base station; and

abnormality determining means determining that the base station other than the master base station is in an abnormal state when the distance between a position by preliminarily given position information of the base station other than the master base station and the second positioning position is larger than a first threshold.

### <Supplementary Note 13>

The correction value processing device described in the supplementary note 11 or 12, wherein the correction value of the master base station includes an ionosphere delay amount and a troposphere delay amount for the master base station.

### <Supplementary Note 14>

The correction value processing device described in any of the supplementary notes 11 to 13, further including correction value transmitting means transmitting the correction value generated by the data processing means to a receiving device estimating the position of itself on the basis of a signal received from the satellite.

### <Supplementary Note 15>

A positioning system having a satellite, a base station, and a correction value processing device, wherein the correction value processing device includes:

first positioning position calculating means calculating a first positioning position of the base station on the basis of the signal received by the data receiving means;

master base station selecting means selecting predetermined number of master base stations in ascending order of a distance between preliminarily given position information of the base station and the first positioning position of the base station;

master base station correction value calculating means generating a correction value of the master base station on the basis of a signal received from the satellite by the master base station;

second positioning position calculating means calculating a second positioning position of a base station other than the master base station by correcting the first positioning position of the base station other than the master base station with the correction value of the master base station by the base station other than the master base station; and

abnormality determining means determining that the base station other than the master base station is in an abnormal state when the distance between a position by preliminarily given position information of the base station other than the master base station and the second positioning position is larger than a first threshold.

### <Supplementary Note 16>

A positioning system having a satellite, a base station, and a correction value processing device, wherein the correction value processing device includes:

first positioning position calculating means calculating a first positioning position of the base station on the basis of the signal received by the data receiving means;

master base station selecting means selecting, as a master base station, a base station whose distance between preliminarily given position information of the base station and the first positioning position of the base station lies in a predetermined range;

master base station correction value calculating means generating a correction value of the master base station on the basis of a signal received from the satellite by the master base station;

second positioning position calculating means calculating a second positioning position of a base station other than the master base station by correcting the first positioning position of the base station other than the master base station with the correction value of the master base station by the base station other than the master base station; and

abnormality determining means determining that the base station other than the master base station is in an abnormal state when the distance between a position by preliminarily given position information of the base station other than the master base station and the second positioning position is larger than a first threshold.

### <Supplementary Note 17>

The positioning system described in the supplementary note 15 or 16, wherein a correction value of the master base station includes an ionosphere delay amount and a troposphere delay amount for the master base station.

### <Supplementary Note 18>

The positioning system described in any of the supplementary notes 15 to 17, further including a receiving device estimating position of itself on the basis of a signal received from the satellite,

wherein the correction value processing device further includes correction value transmitting means transmitting the correction value generated by the data processing unit to the receiving device.

### <Supplementary Note 19>

A storage medium storing a program for detecting an abnormal state of a base station in a positioning system having a satellite and the base station, including:

a process of calculating a first positioning position of the base station on the basis of the signal received by the data receiving means;

a process of selecting predetermined number of master base stations in ascending order of a distance between preliminarily given position information of the base station and the first positioning position of the base station;

a process of generating a correction value of the master base station on the basis of a signal received from the satellite by the master base station;

a second positioning position calculating process of calculating a second positioning position of a base station other than the master base station by correcting the first positioning position of the base station other than the master base station with the correction value of the master base station by the base station other than the master base station; and

a process of determining that the base station other than the master base station is in an abnormal state when the distance between a position by preliminarily given position information of the base station other than the master base station and the second positioning position is larger than a first threshold.

### <Supplementary Note 20>

A storage medium storing a program for detecting an abnormal state of a base station in a positioning system having a satellite and the base station, including:

a process of calculating a first positioning position of the base station on the basis of the signal received by the data receiving means;

a process of selecting, as a master base station, a base station whose distance between preliminarily given position information of the base station and the first positioning position of the base station lies in a predetermined range;

a process of generating a correction value of the master base station on the basis of a signal received from the satellite by the master base station;

a second positioning position calculating process of calculating a second positioning position of a base station other than the master base station by correcting the first positioning position of the base station other than the master base station with the correction value of the master base station by the base station other than the master base station; and

a process of determining that the base station other than the master base station is in an abnormal state when the distance between a position by preliminarily given position information of the base station other than the master base station and the second positioning position is larger than a first threshold.

### <Supplementary Note 21>

The storage medium storing a program described in the supplementary note 19 or 20, wherein a correction value of the master base station includes at least an ionosphere delay amount and a troposphere delay amount for the master base station.

### <Supplementary Note 22>

A state detecting method of detecting an abnormal state of a base station in a positioning system having a satellite and a base station, including:

obtaining a first positioning position of the base station on the basis of a pseudo range between the base station and the satellite obtained on the basis of a signal received from the satellite by the base station;

selecting predetermined number of master base stations in ascending order of a distance between a position by preliminarily given position information of the base station and the first positioning position of the base station;

generating a correction value of the master base station on the basis of the signal received from the satellite by the master base station;

obtaining a second positioning position of a base station other than the master base station by correcting the pseudo range of the base station other than the master base station with the correction value of the master base station; and

determining that the base station other than the master base station is in an abnormal state when the distance between a position by preliminarily given position information of the base station other than the master base station and the second positioning position of the base station other than the master base station is larger than a first threshold.

### <Supplementary Note 23>

The state detecting method described in the supplementary note 22, wherein the correction value of the master base station includes an ionosphere delay amount and a troposphere delay amount for the master base station.

### <Supplementary Note 24>

The state detecting method described in the supplementary note 22 or 23, wherein a correction value of the master base station is a value obtained by subtracting the first positioning position obtained by executing a smoothing process on the pseudo range between the master base station and the satellite from the preliminarily given position of the master base station.

### <Supplementary Note 25>

The state detecting method described in any of the supplementary notes 22 to 24, wherein the positioning system includes the plurality of master base stations,

wherein the correction value used to correct the pseudo range of a base station other than the mater base station is an average value of the correction values generated by the plurality of master base stations.

### <Supplementary Note 26>

The state detecting method described in any of the supplementary notes 22 to 25, wherein the positioning system has a first master base station and a second master base station,

wherein a second positioning position of the first master base station is obtained, which is derived by correcting a pseudo range between the first master base station and the satellite obtained on the basis of a signal received from the satellite by the first master base station with a correction value of the second master base station;

when the distance between a position by preliminarily given position information of the first master base station and the second positioning position of the first master base station is larger than a second threshold, it is determined that the first master base station is in an abnormal state; and

when it is determined that the first master base station is in an abnormal state, one of base stations other than the plurality of master base stations is selected as the first master base station.

### <Supplementary Note 27>

The state detecting method described in any of the supplementary notes 22 to 26, wherein at the time of obtaining a first positioning position of the base station, a satellite transmitting a signal to be received is selected from the plurality of satellites.

### <Supplementary Note 28>

The state detecting method described in the supplementary note 27, wherein as the satellite transmitting the signal to be received, a satellite whose elevation angle is larger than a predetermined angle or a satellite which can be seen from all of base stations included in the positioning system is selected from the plurality of satellites.

### <Supplementary Note 29>

The state detecting method described in any of the supplementary notes 22 to 28, wherein the first threshold is determined with reference to a predetermined probability distribution function.

### <Supplementary Note 30>

The state detecting method described in any of the supplementary notes 22 to 29, wherein the first threshold is determined on the basis of the number of the satellites and a disposition state of the satellites.

### <Supplementary Note 31>

A correction value processing device including:

data receiving means receiving a signal received from a satellite by a base station; and

data processing means obtaining a first positioning position of the base station on the basis of a pseudo range between the base station the satellite derived on the basis of the signal received by the data receiving means, selecting predetermined number of master base stations in ascending order of a distance between a position by preliminarily given position information of the base station and the first positioning position of the base station, generating a correction value of the master base station on the basis of a signal received from the satellite by the master base station, obtaining a second positioning position of a base station other than the master base station by correcting the pseudo range of the base station other than the master base station with the correction value of the master base station, and determining that the base station other than the master base station is in an abnormal state when the distance between a position by preliminarily given position information of the base station other than the master base station and the second positioning position of the base station other than the master base station is larger than a first threshold.

### <Supplementary Note 32>

The correction value processing device described in the supplementary note 31, wherein the correction value of the master base station includes an ionosphere delay amount and a troposphere delay amount for the master base station.

### <Supplementary Note 33>

The correction value processing device described in the supplementary note 31 or 32, further including correction value transmitting means transmitting the correction value generated by the data processing means to a receiving device estimating the position of itself on the basis of a signal received from the satellite.

### <Supplementary Note 34>

A positioning system having a satellite, a base station, and a correction value processing device, wherein the correction value processing device includes:

data processing means obtaining a first positioning position of the base station on the basis of a pseudo range between the base station and the satellite derived on the basis of a signal received from the satellite by the base station, selecting predetermined number of master base stations in ascending order of a distance between a position by preliminarily given position information of the base station and the first positioning position of the base station, generating a correction value of the master base station on the basis of a signal received from the satellite by the master base station, obtaining a second positioning position of a base station other than the master base station by correcting the pseudo range of the base station other than the master base station with the correction value of the master base station, and determining that the base station other than the master base station is in an abnormal state when the distance between a position by preliminarily given position information of the base station other than the master base station and the second positioning position of the base station other than the master base station is larger than a first threshold.

### <Supplementary Note 35>

The positioning system described in the supplementary note 34, wherein the correction value of the master base station includes an ionosphere delay amount and a troposphere delay amount for the master base station.

### <Supplementary Note 36>

The positioning system described in the supplementary note 34 or 35, further including a receiving device estimating position of itself on the basis of a signal received from the satellite,

wherein the correction value processing device further includes correction value transmitting means transmitting the correction value generated by the data processing unit to the receiving device.

### <Supplementary Note 37>

A storage medium storing a program for detecting an abnormal state of a base station in a positioning system having a satellite and the base station, including:

a process of obtaining a first positioning position of the base station on the basis of a pseudo range between the base station and the satellite derived on the basis of a signal received from the satellite by the base station;

a process of selecting predetermined number of master base stations in ascending order of a distance between a position by preliminarily given position information of the base station and the first positioning position of the base station;

a process of generating a correction value of the master base station on the basis of a signal received from the satellite by the master base station;

a process of obtaining a second positioning position of a base station other than the master base station by correcting the pseudo range of the base station other than the master base station with the correction value of the master base station; and

a process of determining that the base station other than the master base station is in an abnormal state when the distance between a position by preliminarily given position information of the base station other than the master base station and the second positioning position of the base station other than the master base station is larger than a first threshold.

### <Supplementary Note 38>

The storage medium storing a program described in the supplementary note 37, wherein a correction value of the master base station includes at least an ionosphere delay amount and a troposphere delay amount for the master base station.

Although the state detecting method and the like of the present invention have been described on the basis of the exemplary embodiments, obviously, the invention is not limited to the exemplary embodiments and can include various modifications, changes, and improvements in the exemplary embodiments within the scope of the present invention and on the basis of the fundamental technical idea of the present invention. Within the scope of claims of the present invention, various disclosure elements can be variously combined, replaced, or selected. Further problems, objects, and expansion modes of the present invention will become apparent also from the entire disclosure articles of the present invention including the scope of claims.

The present application claims priority based on Japanese Patent Application No. 2013-035783 filed on Feb. 26, 2013, the entire disclosure of which is incorporated herein.

### INDUSTRIAL APPLICABILITY

The present invention is not limited to the foregoing exemplary embodiments but can be preferably applied to a positioning system using a plurality of base stations.

### REFERENCE SIGNS LIST

101 differential GPS
201, 20n GPS satellite
301, 302, 303, 304 base station
401 correction value processing device
402 data receiving unit
403 data processing unit
404 data holding unit
405 correction value transmitting unit
406 first positioning position calculating unit
407 master base station selecting unit
408 master base station correction value calculating unit
409 second positioning position calculating unit
410 abnormality determining unit
501 broadcast transmitting device
601 receiving device

What is claimed is:

1-21. (canceled)

22. A state detecting method of detecting an abnormal state of a plurality of base stations in a positioning system having a satellite and the plurality of base stations, comprising:
obtaining a first positioning position of the base station on the basis of a signal received from the satellite by the base station;
selecting, as a master base station, a base station whose distance between preliminarily given position information of the base station and the first positioning position of the base station lies in a predetermined range;
generating a correction value of the master base station on the basis of a signal received from the satellite by the master base station;
obtaining a second positioning position of a base station other than the master base station by correcting the first positioning position of the base station other than the master base station with the correction value of the master base station by the base station other than the master base station; and
determining that the base station other than the master base station is in an abnormal state when the distance between a position by preliminarily given position information of the base station other than the master base station and the second positioning position is larger than a first threshold.

23. The state detecting method according to claim 22, wherein the correction value of the master base station includes an ionosphere delay amount and a troposphere delay amount for the master base station.

24. The state detecting method according to claim 22, wherein a correction value of the master base station is a value obtained by subtracting the first positioning position obtained by executing a smoothing process on the pseudo range between the master base station and the satellite from the preliminarily given position of the master base station.

25. The state detecting method according to claim 22, wherein the positioning system includes the plurality of master base stations,
wherein the correction value used to correct the pseudo range of a base station other than the mater base station is an average value of the correction values generated by the plurality of master base stations.

26. The state detecting method according to claim 22, wherein the positioning system has a first master base station and a second master base station,
wherein a second positioning position of the first master base station is obtained, which is derived by correcting a pseudo range between the first master base station and the satellite obtained on the basis of a signal received from the satellite by the first master base station with a correction value of the second master base station;
when the distance between a position by preliminarily given position information of the first master base station and the second positioning position of the first master base station is larger than a second threshold, it is determined that the first master base station is in an abnormal state; and
when it is determined that the first master base station is in an abnormal state, one of base stations other than the plurality of master base stations is selected as the first master base station.

27. The state detecting method according to claim 22, wherein a satellite transmitting a signal to be received is selected from the plurality of satellites.

28. The state detecting method according to claim 27, wherein as the satellite transmitting the signal to be received, a satellite whose elevation angle is larger than a predetermined angle or a satellite which can be seen from all of base stations included in the positioning system is selected from the plurality of satellites.

29. The state detecting method according to claim 22, wherein the first threshold is determined with reference to a predetermined probability distribution function.

30. The state detecting method according to claim 22, wherein the first threshold is determined on the basis of the number of the satellites and a disposition state of the satellites.

31. A correction value processing device comprising:
data receiving unit receiving a signal received from a satellite by a base station;
first positioning position calculating unit calculating a first positioning position of the base station on the basis of the signal received by the data receiving unit;
master base station selecting unit selecting, as a master base station, a base station whose distance between preliminarily given position information of the base station and the first positioning position of the base station lies in a predetermined range;
master base station correction value calculating unit generating a correction value of the master base station on the basis of a signal received from the satellite by the master base station;
second positioning position calculating unit calculating a second positioning position of a base station other than the master base station by correcting the first positioning position of the base station other than the master base station with the correction value of the master base station by the base station other than the master base station; and
abnormality determining unit determining that the base station other than the master base station is in an abnormal state when the distance between a position by preliminarily given position information of the base station other than the master base station and the second positioning position is larger than a first threshold.

32. The correction value processing device according to claim 31, wherein the correction value of the master base station includes an ionosphere delay amount and a troposphere delay amount for the master base station.

33. The correction value processing device according to claim 31, further comprising correction value transmitting unit transmitting the correction value generated by the data processing unit to a receiving device estimating the position of itself on the basis of a signal received from the satellite.

34. A positioning system having a satellite, a base station, and a correction value processing device, wherein the correction value processing device comprises:
first positioning position calculating unit calculating a first positioning position of the base station on the basis of the signal received by the data receiving unit;
master base station selecting unit selecting, as a master base station, a base station whose distance between preliminarily given position information of the base station and the first positioning position of the base station lies in a predetermined range;
master base station correction value calculating unit generating a correction value of the master base station on the basis of a signal received from the satellite by the master base station;
second positioning position calculating unit calculating a second positioning position of a base station other than the master base station by correcting the first positioning position of the base station other than the master base station with the correction value of the master base station by the base station other than the master base station; and
abnormality determining unit determining that the base station other than the master base station is in an abnormal state when the distance between a position by preliminarily given position information of the base station other than the master base station and the second positioning position is larger than a first threshold.

35. The positioning system according to claim 34, wherein a correction value of the master base station includes an ionosphere delay amount and a troposphere delay amount for the master base station.

36. The positioning system according to claim 34, further comprising a receiving device estimating position of itself on the basis of a signal received from the satellite,
wherein the correction value processing device further comprises correction value transmitting unit transmitting the correction value generated by the data processing unit to the receiving device.

37. A storage medium storing a program for detecting an abnormal state of a base station in a positioning system having a satellite and the base station, comprising:
a process of calculating a first positioning position of the base station on the basis of the signal received by the data receiving unit;
a process of selecting, as a master base station, a base station whose distance between preliminarily given position information of the base station and the first positioning position of the base station lies in a predetermined range;
a process of generating a correction value of the master base station on the basis of a signal received from the satellite by the master base station;
a second positioning position calculating process of calculating a second positioning position of a base station other than the master base station by correcting the first positioning position of the base station other than the master base station with the correction value of the master base station by the base station other than the master base station; and
a process of determining that the base station other than the master base station is in an abnormal state when the distance between a position by preliminarily given position information of the base station other than the master base station and the second positioning position is larger than a first threshold.

38. The storage medium storing a program according to claim 37, wherein a correction value of the master base station includes at least an ionosphere delay amount and a troposphere delay amount for the master base station.
